(19) United States
(12) Patent Application Publication
(10) Pub. No.: US 2026/0054354 A1
(43) Pub. Date: Feb. 26, 2026

(54) Clamping device and testing device

(71) Applicant: ept Holding GmbH & Co. KG, Peiting (DE)

(72) Inventor: Stefan Kienle, Peiting (DE)

(73) Assignee: ept Holding GmbH & Co. KG, Peiting (DE)

(21) Appl. No.: 18/814,672

(22) Filed: Aug. 26, 2024

(51) Int. Cl. B25B 5/00; B25B 5/02; B25B 5/16

(52) U.S. Cl. CPC B25B 5/006; B25B 5/02; B25B 5/16

(57) ABSTRACT

A clamping device for clamping or gripping an object comprising a basic body which comprises an interface for the connection to a working or testing device, the basic body extending along a central axis and comprising at least four guides disposed opposite of each other in pairs which extend radial to the central axis, and at least four clamping elements respectively one of which, at least in portions, is introduced into a guide, the guide supporting and guiding the clamping element radial to the central axis with a linear degree or freedom, and the clamping element having at least one coupling surface which is oriented so that it is inclined with respect to the central axis.

### RELATED APPLICATIONS

This application is related to DE Application No. 10 2023 104 774.4, filed Feb. 27, 2023, which is hereby incorporated by reference.

### FIELD

The invention relates to a clamping device for clamping or gripping an object comprising a basic body which has an interface for the connection to a working or testing device, the basic body extending along a central axis and having at least four guides disposed opposite of each other in pairs which extend radial to the central axis, and at least four clamping elements respectively one of which, at least in portions, is introduced into a guide, the guide supporting and guiding the clamping element radial to the central axis with a linear degree or freedom, and the clamping element having at least one coupling surface which is oriented so that it is inclined with respect to the central axis. The clamping device further comprises at least two coupling elements each of which is kinematically coupled to two clamping elements disposed opposite of each other radial to the central axis, and at least two activation elements each of which is connected to one of the coupling elements, the activation elements being arranged so that they are independently movable relative to the basic body at least in a direction parallel to the central axis. The invention further relates to a testing device including a clamping device, and to a method for measuring an object by means of a testing device.

### BACKGROUND

In various applications, an object is to be clamped in a clamping device so that a central axis of the object is oriented coaxial to an axis of rotation of the clamping device. In lathes, a workpiece to be machined is to be clamped in a clamping device so that its central axis is oriented coaxial to the axis of rotation of the lathe. In addition, optical inspection or measuring devices exist in which an object is first clamped in a clamping device and then rotated together with the clamping device. During this rotation, a camera captures a plurality of images of the object. These images will then be computationally superimposed, and a volume model of the object is produced in this way. For this and further applications, it is essential that the central axis of the object and the axis of rotation of a clamping device are oriented coaxial with respect to each other with the least possible deviation to achieve high quality results. Coaxial clamping about their central axis can be readily realised with high precision by known means with objects having a regular, symmetrical shape. For example, chucks having three or four clamping jaws exist which are well suited for the precise clamping of objects having a cylindrical or square shape. However, these known chucks only exhibit limited suitability for aligning and clamping objects having an irregular shape with positional accuracy with respect to the axis of rotation.

For coaxially clamping objects in a clamping device, a centring device may be integrated in the clamping device which first centres the object relative to the axis of rotation of the clamping device. Then, clamping jaws are applied and clamped to the already centred object. Such a solution is described, for example, in DE102006027988B4. A disadvantage of this solution is that a clamping device including an additional centring device has a complex design and requires a large number of components.

For clamping objects having a square cross section, clamping devices exist in which four clamping jaws are kinematically coupled to each other so that the central axis of an object is centred with respect to the axis of rotation of the clamping device. Such a compensating clamping device is described, for example, in DE102019100089B3. In this clamping device, a compensation mechanism is provided which comprises a plurality of components which rotate parallel to the axis of rotation of the clamping device while clamping about an axis. The described clamping device comprises numerous components and therefore requires a relatively large installation space.

### SUMMARY

The object of the invention is the proposal of solutions by means of which objects having an irregular shape can be positioned and fixed with their central axis coaxial to the axis of rotation of a device in a simplified manner.

This object of the invention is solved by a clamping device for clamping or gripping an object comprising
a basic body which has an interface for the connection to a working or testing machine, the basic body extending along a central axis and including at least four guides disposed opposite of each other in pairs which extend radial to the central axis,
at least four clamping elements respectively one of which, at least in portions, is introduced into a guide, the guide supporting and guiding the clamping element radial to the central axis with a linear degree or freedom, and the clamping element having at least one coupling surface which is oriented so that it is inclined with respect to the central axis,
at least two coupling elements each of which is kinematically coupled to two clamping elements disposed opposite of each other radial to the central axis, the coupling element including two transmission elements spaced apart from each other radial to the central axis which, at least in portions, extend about the central axis tangential to the circumferential direction, each transmission element being in contact with or being contactable to a coupling surface of a clamping element, and the two coupling elements being supported in or on the basic body so that they are independently movable in a direction parallel to the central axis,
at least two activation elements each of which is connected to one of the coupling elements, the activation elements being arranged so that they are independently movable relative to the basic body at least in a direction parallel to the central axis,
the coupling element connected thereto also moving in the direction of the central axis during a movement of an activation element in the direction of the central axis, and the interaction of the two transmission elements of the coupling element with respectively one coupling surface of a clamping element translating the movement of the coupling element into a movement of two clamping elements arranged opposite of each other radial to the central axis in direction radial to the central axis.

The clamping device according to the invention serves the clamping or gripping of an object, a central axis of the object being aligned substantially coaxial to the axis of rotation or the central axis of the clamping device. An object may, for example, be a component which is to be machined or conveyed to a following processing step in a process. Alternatively, the object may also be a component which is to be inspected or measured. Here, the object may have a plurality of subsections at least the subsection which is introduced into the clamping device of which has an irregular cross section. An irregular cross section is to be understood to be a cross section which is not formed so that it is rotationally symmetrical about a central axis. For example, the irregular cross section of a subsection introduced into the clamping device may have a square cross section. For example, some objects produced by punching have such a square cross section. The central axis of the object is to be understood to be an axis along which the object extends. The object, at least in portions, may be formed so that it is rotationally symmetrical to the central axis. It is also possible that the object, at least in portions, is not formed so that it is rotationally symmetrical to the central axis.

The clamping device according to the invention comprises a basic body which supports and accommodates the other components of the clamping device. A subsection of this basic body is formed by an interface which is provided for the connection to a working or testing device. The basic body extends along a central axis which, at the same time, forms the axis around which the clamping device rotates in the state connected to a working or testing device. Therefore, the central axis may also be referred to as the axis of rotation of the clamping device. The basic body comprises four guides respectively two of which are arranged opposite of each other in a direction radial to the central axis. The guides extend in the radial direction to the central axis. Furthermore, at least four clamping elements are provided respectively one of which is introduced into one of the guides in the basic body. The guides and the clamping elements interact so that each clamping element has a linear degree or freedom for a movement towards the central axis or away from the central axis. Each of the clamping elements comprises at least one coupling surface which is provided for a kinematic coupling to one of the coupling elements. The coupling surface is oriented so that it is inclined with respect to the central axis and inclined with respect to the linear degree of freedom of the guides. The clamping device further comprises at least two coupling elements. Each of these coupling elements is kinematically coupled to respectively two opposing clamping elements via the coupling surface. This is to be understood to mean that the movement of a coupling element is translated into a movement of two clamping elements disposed opposite of each other. Each coupling element includes two transmission elements spaced apart from each other in the radial direction to the central axis which can be brought in contact with respectively one coupling surface of a clamping element. In a state in which an object is clamped in the clamping device, the transmission elements are respectively in contact with a coupling surface. In a state in which no object is clamped, a small distance may temporarily exist between a transmission element and a coupling surface. The two coupling elements are supported in or on the base element so that they, independent of each other, are linearly movable in a direction parallel to the central axis. The clamping device further comprises at least two activation elements respectively one of which is connected to a coupling element. This connection may be implemented so that it is rigid or movable. The two activation elements are also independently movable relative to the basic body. Optionally, each activation element may be supported in or on the basic body so that it is movable parallel to the central axis. According to the invention, the activation elements are provided for inducing a movement which may be realised, for example, by an actuator connected to an activation element. During such an initiation of a movement, an activation element is moved in the direction of the central axis. As a result of the connection to the coupling element, the coupling element is also moved in the direction of the central axis. Owing to the interplay or interaction of the transmission elements and respectively one coupling surface of two clamping elements disposed opposite of each other in the radial direction to the central axis, the movement of the coupling element, in turn, is translated into a radial movement of these two clamping elements disposed opposite of each other. Here, the two coupling elements can be moved independently which, due to the translation, results in an independent movement of two pairs of clamping elements respectively disposed opposite of each other. Due to the fact that the two pairs of clamping elements disposed opposite of each other can be independently moved towards or away from the central axis in the radial direction, the clamping device according to the invention renders the clamping of objects having an irregular cross section possible. It is possible that, in the clamped state, one pair of clamping elements has a larger distance to each other than the other pair of clamping elements in the radial direction to the central axis. In this way, particularly the clamping of an object having a rectangular cross section is possible. In addition, other shapes of cross sections of an object can also be clamped in a centred manner by the altogether four clamping elements. For the synchronised movement of opposing clamping elements, respectively one coupling element is provided. The two coupling elements are movable independently, likewise, the activation elements connected to the coupling element are movable independently. The activation elements may be independently moved by an operator, for example manually and/or using an actuator. Alternatively, it is possible to move the activation elements together by interposing a compensation mechanism so that the clamping device is operable for clamping by means of a single actuator, and the movement of all four clamping elements relative to each other is kinematically coupled. The various options for moving the activation elements will be described later in connection with various embodiments.

The clamping device according to the invention has a simple and robust design and comprises a smaller number of components as compared to prior art. The coupling elements are supported so that they are linearly movable in the direction of the central axis in a simple manner and kinematically connected to two clamping elements, respectively. Such a linear support of the coupling elements can be produced in a simple manner and has the effect that the clamping device according to the invention has a low weight. The clamping device according to the invention can be produced in extremely small dimensions due to its simple design and is then particularly suitable for accommodating small, fragile objects. Owing to the small installation space and the low weight, the clamping device is particularly suitable for the use in testing devices by means of which small objects are to be precisely examined. The possibility to move the opposite pairs of clamping elements separately and yet in an intrinsically synchronised manner renders a precisely reproducible clamping of an object in the clamping device possible. Of course, the clamping device according to the invention may also be dimensioned so that it is larger and be used as a clamping device for, for example, a work machine. In larger dimensions, the simple design including only few components also results in a simple and cost-effective manufacturability of the clamping device.

In one embodiment, it is contemplated that the interface is implemented as a cylindrical pin or cone which extends along the central axis, and the interface is disposed on the, in the direction of the central axis of the guides, opposite side of the basic body. The interface is formed so that it is positively and/or non-positively connectable to an associated counter-interface on a testing machine, work machine or testing device.

Furthermore, it is contemplated that the four guides are respectively spaced apart by 90° in the circumferential direction around the central axis. In this regular arrangement, respectively two clamping elements are disposed opposite of each other so that they are offset by 180° with respect to the central axis. This arrangement is particularly favourable for clamping objects having a rectangular cross section.

In another embodiment, it is contemplated that the guide, at least in portions, is formed by a groove in the basic body which transitions into a receiving space on its side facing the central axis in the radial direction, the receiving space being formed by a hollow space extending, at least in portions, in the interior of the basic body along the central axis and provided for accommodating an object inserted between the clamping elements. Grooves can be integrated in the basic body in a simple manner, for example, by milling. A receiving space is preferably provided in the interior of the basic body so that a good flow of forces from the clamping elements supported in grooves to the clamped object disposed in the receiving space is ensured.

In an advantageous implementation, it is contemplated that the receiving space has a round or square cross section. Preferably, the receiving space is regularly formed in the circumferential direction around the central axis to render the introduction of objects in various orientations between the four clamping elements possible. However, the receiving space may also be formed irregularly and, for example, have the negative shape of an object to be clamped.

In one embodiment, it is contemplated that the guide has a cavity for accommodating a clamping element, at least one insertion element being provided which protrudes into the cavity and is provided for the engagement in a clamping element to fix the clamping element in a direction parallel to the central axis, the clamping element being movable radial to the central axis. In this embodiment, the guide is implemented as a cavity or hollow space and may be formed, for example, by a groove. For securing the clamping element introduced into the cavity in the direction of the central axis, at least one insertion element is provided which protrudes into the cavity. Such an insertion element may be, for example, a cylindrical pin or a fin-like protrusion on a side wall of the cavity. Of course, the principle of the guide can also be reversed: the guide may be implemented as a protrusion while the clamping element, in this case, has a cavity which is placed on the guide implemented as a protrusion. In this case, the clamping element may be secured in the direction of the central axis by the guide implemented as a protrusion and having an undercut into which a subsection of the slid-on clamping element is introduced.

Preferably, it is contemplated that the guides are disposed on or in a face side of the basic body in the direction of the central axis. Preferably, the guides are disposed on the face side of the basic body located opposite of the interface in the direction of the central axis.

In another embodiment, it is contemplated that the guide has a cavity for accommodating a clamping element, the cavity being defined by a guiding edge, respectively, which projects beyond adjoining portions of the basic body in the direction of the central axis on sides disposed opposite of each other in the circumferential direction around the central axis. In this embodiment, each guide is defined by a guiding edge on sides disposed opposite of each other in the circumferential direction. Here, this guiding edge projects beyond an adjacent surface of the basic body preferably implemented so that it is planar. Owing to the projecting guiding edge, a simple design of the support of the clamping elements in the guide is possible. For example, owing to the guiding edge or owing to the two guiding edges of a guide, recesses may be integrated which in turn serve to accommodate guide elements, for example insertion elements. In addition, the provision of projecting guiding edges renders an easy accessibility of the coupling surfaces of the clamping elements possible which can also be made accessible by means of recesses in the guiding edges.

Skillfully, it is contemplated that the guiding edge has at least one recess which extends tangential to the circumferential direction of the central axis, an insertion element or a transmission element being introduced into this recess. Such a recess can be integrated in a simple manner from a direction tangential to the circumferential direction around the central axis, for example, by drilling or milling. The recess may fulfil various purposes and, for example, serve as a through guide for a transmission element through the guiding edge towards to the coupling surface on clamping element.

In an advantageous implementation, it is contemplated that the clamping element, at least in portions, has a disk-shaped design and is introduced into a cavity disposed in the guide in sliding fit. Here, disk-shaped is to be understood to mean that the clamping element has two surfaces implemented so that they are planar and oriented so that they parallel to each other. Here, the surface area of these surfaces is considerably larger than the other surfaces of the clamping element. A clamping element formed in this way can be introduced into a guide implemented as a groove in sliding or clearance fit. Such a fit is to be understood to mean that the clamping element is shiftable within the guide in a sliding manner, however, without a clearance being present for a movement of the clamping element in the guide tangential to the circumferential direction around the central axis.

Furthermore, it is contemplated that the clamping element comprises a clamping surface which is oriented towards the central axis and extends parallel to the central axis. Such a clamping surface may have surface properties deviating from the other surfaces of the clamping element. For example, the clamping surface may be implemented so that it is ground and cured to exclude wear of the clamping surface and thereby an inaccuracy in clamping objects in repeated use of the clamping device.

In one embodiment, it is contemplated that, in the clamping element, the coupling surface is disposed in a recess which, at least partly, extends through the clamping element tangential to the circumferential direction around the central axis. The arrangement of the coupling surface in a recess results in a compact design of the clamping element. Alternatively, however, the coupling surface may also be disposed on an outer surface or a protruding portion on the clamping element.

In an advantageous implementation, it is contemplated that the recess is implemented as an elongated hole, two opposing coupling surfaces being provided which are oriented parallel to each other and implemented so that they are planar, the coupling surfaces defining the longer side of the elongated hole. In this embodiment, the recess including the coupling surface is implemented as an elongated hole. In this way, two coupling surfaces can be arranged so that they are disposed opposite of each other in a simple manner.

Preferably, it is contemplated that the coupling surface is oriented at an acute angle to the central axis. An acute angle is to be understood to be an angle of 1° to 89°. The angle at which the coupling surface is disposed is essential for the translation of the movement of the coupling elements in the direction of the central axis into a movement of the clamping elements radial to the central axis. The sharper the selected angle is, the larger is the achievable clamping force between two clamping elements disposed opposite of each other.

In one embodiment, it is contemplated that the clamping element has at least one guide recess which, at least in portions, extends through the clamping element tangential to the circumferential direction around the central axis, an insertion element protruding into the guide recess in sliding fit. The guide recess serves as a counterpart to an insertion element. Preferably, the guide recess is implemented as an elongated hole the longer side of which is oriented radial to the central axis. An insertion element fixedly positioned with respect to the guide extends through the guide recess. The clamping element, guided by the insertion element introduced into the guide recess, is movably guided. Preferably, at least two guide recesses per clamping element are provided. Here as well, the principle of the guide or support may be reversed: At least one protruding portion, for example, in the shape of a fin which protrudes into a recess, for example, a groove in or on the guide may be provided on the clamping element. The described mechanism serves to secure or fix clamping elements relative to the guide in the direction of the central axis.

In one embodiment, it is contemplated that the coupling element is implemented so that it is rigid, the coupling element particularly having an integral basic body into which the transmission elements are introduced. An integral basic body has a compact design and is stable. The at least two transmission elements are fixedly inserted in the basic body. Alternatively, it is also possible that the basic body has a multi-part design, or the transmission elements are implemented as subsections of the basic body.

In an advantageous implementation, it is contemplated that the coupling element, in portions, has a fork-shaped design, at least two supports spaced apart from each other radial to the central axis being provided which, at least in portions, extend parallel to the central axis, a central portion being disposed between the supports and connecting the supports, and each support supporting a transmission element, a distance being present between the connection of the central portion to the supports and the connection of the transmission elements to the supports. In this embodiment, the coupling element has a fork-shaped design. For this purpose, at least two supports oriented parallel to the central axis are provided which are connected to each other by a central portion. On their end facing away from the central portion, the supports respectively support a transmission element. Such a fork-shaped design ensures that each coupling element engages around the receiving space located around the central axis but does not penetrate it so that no collision of the coupling elements with an object inserted in the receiving space will occur.

Furthermore, it is contemplated that each support has at least one sliding surface which is oriented parallel to the central axis, and the sliding surfaces are slidably supported in a subsection of the basic body. In this embodiment, the coupling element is supported in the basic body by means of a sliding bearing. For this purpose, one or a plurality of sliding surfaces preferably having a planar design are disposed on each of the supports. These sliding surfaces abut on counter surfaces disposed in the basic body in sliding fit. Owing to the orientation of the sliding surfaces parallel to the central axis, these render a linear movement of the coupling element relative to the basic body in the direction of the central axis possible but prevent movements of the coupling element in the radial direction to the central axis.

Advantageously, it is contemplated that the coupling element comprises four supports which are disposed opposite of each other in pairs tangential to the circumferential direction around the central axis and respectively connect a transmission element and two supports disposed opposite of each other tangential to the circumferential direction around the central axis to each other. In this embodiment, each coupling element has four supports respectively two of which together support a transmission element. Owing to the accommodation of a transmission element by two supports, a precise and stable alignment of each transmission element relative to a coupling surface of a clamping element is ensured. Owing to the arrangement of the supports in pairs, the individual supports may have smaller dimensions than in case of the provision of only one support per transmission element.

In another embodiment, it is contemplated that the central portion has an internal guide, a guiding spike being introduced through the internal guide of the central portions of the two coupling elements in sliding fit and guiding the two coupling elements relative to each other in the direction of the central axis. In this embodiment, a guiding spike aligns the two coupling elements with respect to each other and guides them in the direction of the central axis. In the two central portions of the coupling elements, respectively one internal guide is integrated through which the guiding spike is inserted. Preferably, each internal guide has an irregular cross section in a plane perpendicular to the central axis, and the guiding spike has a corresponding negatively shaped irregular cross section. When the guiding spike is inserted through the internal guides, a rotation of the coupling elements in an axis of rotation parallel to the central axis is prevented by the guide including the guiding spike. Here, the guiding spike is preferably formed like a sword. The guiding spike may be fixedly connected to the basic body or a sliding element of a compensation mechanism which will be described later.

In an advantageous implementation, it is contemplated that the coupling elements, at least in portions, extend through or engage around each other. In this embodiment, the two coupling elements are, in portions, disposed in each other or interlaced. This results in a compact design of the clamping device.

In another embodiment, it is contemplated that the coupling elements are designed so that they are substantially symmetrical to the central axis. The design of the coupling elements may be symmetrical to a plane which extends through the central axis parallel to the central axis. Furthermore, the design may be completely symmetrical in the radial direction around the central axis. Since each coupling element is kinematically connected to two clamping elements disposed opposite of each other a symmetrical design results in a uniform flow of forces to both coupled clamping elements. Such a uniform flow of forces, in turn, results in a high reproducibility of the position when clamping an object in the clamping device. In addition, the entire clamping device can be dimensioned so that it is space-saving and/or slim.

In one embodiment, it is contemplated that the activation elements are disposed on the side of the coupling elements located opposite of the transmission elements in the direction of the central axis and extend away from the coupling elements in the direction of the central axis. In this embodiment, the activation elements are disposed or mounted on the side of the coupling elements facing away from the transmission elements and thus the clamping elements. Here, the activation elements may be disposed so that they do not project beyond the coupling elements in the radial direction to the central axis and extend away from the coupling elements in the direction of the central axis. Alternatively, the activation elements may also be disposed in another position and, for example, project beyond the coupling elements towards the outside in a direction radial to the central axis.

In another embodiment, it is contemplated that each activation element is connected to an actuator, each activation element being independently movable in the direction of the central axis by means of an actuator. An actuator is to be understood to be an assembly which induces a movement or transmits it to the activation element. The force or energy required for inducing the movement may be applied manually by an operator or provided for by a drive, for example, an electric motor. Each activation element is connected to a separate actuator so that the position of the two pairs of clamping elements arranged opposite of each other, in their guides, can also be moved, changed, or adjusted separately with respect to each other. In this embodiment, the force with which the pairs of clamping elements disposed opposite of each other clamp an object in the clamping device can be individually and independently adjusted. Alternatively, the clamping device may comprise a compensation mechanism which automatically distributes the movement induced by a single actuator to all four clamping elements. Such an embodiment including a compensation mechanism will be described later.

In an advantageous implementation, it is contemplated that the actuator comprises a nut supported in the basic body parallel to the central axis so that it is linearly immobile but rotatable about the central axis and having a female thread extending parallel to the central axis, the activation element comprising a male thread which is in engagement with the female thread of the nut. In this embodiment, a nut is provided which is rotated about the central axis by an operator for operating the actuator. This rotational movement of the nut is translated into a linear movement of the activation element in the direction of the central axis by means of a combination of a female thread in the nut and a male thread on the activation element. Of course, an actuator may also have another design and comprise, for example, a hydraulic or pneumatic cylinder which moves the activation element along the central axis upon operation of an operating element.

In another embodiment, it is contemplated that a compensation mechanism is provided which is connected to the activation elements, the compensation mechanism being provided to compensate a difference in the position of the coupling elements in the direction of the central axis and therefore a difference in the distance between clamping elements disposed opposite of each other radial to the central axis. In this embodiment, a compensation mechanism is connected to the at least two activation elements. When clamping an object having an irregular cross section one pair clamping elements arranged opposite of each other abuts on the object prior to the other pair. After this abutment, of one of the coupling elements and therefore at least of one of the activation elements can no longer be moved further in the direction of the central axis due to the kinematic coupling. However, the other pair of clamping elements and therefore the other coupling element including the activation element connected thereto have to be moved further on to clamp the object. The compensation mechanism ensures that, after the abutment of the first pair of clamping elements, the second pair of clamping elements moves further on until it also abuts on and clamps the object. This object is fulfilled by the compensation mechanism by transmitting the movement of an actuator to the activation elements while compensating different positions of the coupling elements. An advantage of the provision of a compensation mechanism is that the clamping force or the clamping pressure of all four clamping elements is substantially equally large which benefits centred clamping. In addition, the regularly distributed clamping pressure results in that the object is not unidirectionally or irregularly deformed when being clamped.

Skillfully, it is contemplated that the compensation mechanism is disposed on the side of the coupling elements located opposite of the clamping elements in the direction of the central axis. This position of the compensation mechanism is particularly favourable when an actuator is also disposed on the side the coupling elements located opposite of the clamping elements. Preferably, the elements are arranged along the central axis in the following order: coupling elements, activation elements, compensation mechanism, and actuator.

Furthermore, it is contemplated that the compensation mechanism is connected to an actuator via a sliding element, the sliding element being movable in the direction of the central axis by the actuator. The compensation mechanism comprises a sliding element which can be linearly moved in the direction of the central axis by an actuator.

Advantageously, it is contemplated that the actuator comprises a nut linearly immobile in the basic body parallel to the central axis but supported so that it is rotatable about the central axis and having a female thread which extends parallel to the central axis, and that the sliding element comprises a subsection having a male thread extending parallel to the central axis, the male thread being in engagement with the female thread of the nut. In this embodiment, the actuator comprises a nut rotatably supported in the basic body which, upon initiation of a rotational movement, induces a linear movement of the sliding element along the central axis by means of a thread. Here as well, it is of course possible that the actuator has another design and, for example, comprises a hydraulic or pneumatic cylinder for moving the sliding element.

In one embodiment, it is contemplated that the sliding element comprises at least one sliding rail which is formed by a recess in the sliding element, the sliding rail extending perpendicular to the central axis. The sliding rail in the sliding element serves as a support for other, movably arranged components of the compensation mechanism. The sliding rail extends through the sliding element in a first direction perpendicular to the central axis and extends in a second direction perpendicular to the central axis, the first direction and the second direction being oriented perpendicular to each other. The sliding rail may be implemented, for example, as an elongated hole the longer side of which extends along the second direction. Alternatively, the sliding rail may also be formed by a protrusion which is disposed on an outer surface of the sliding element and extends perpendicular to the central axis.

Furthermore, it is contemplated that the compensation mechanism comprises at least two transmission members which respectively extend along a member axis, each transmission member being rotatably connected to an activation element at a first end, and the transmission members being rotatably connected to each other and connected to the sliding element so that are linearly shiftable relative to the sliding rail at a second end disposed opposite of the first end in the direction of the member axis. The transmission members serve to movably connect the activation elements to the sliding element. Each of the transmission members extends along a member axis and has two ends disposed opposite of each other in this direction. Such a transmission member may be formed, for example, like a chain link. A first end of each transmission member is rotatably connected to an activation element. Here, the transmission member is rotatably connected to the activation element in a plane parallel to the central axis. Each of the transmission members is, also rotatably, connected to the second end of the other transmission member at a second end. This connection is implemented so that the two transmission members are rotatably supported in the same plane with respect to each other like the transmission members relative to the activation element. At the same time, the two second ends of the transmission members are supported in the sliding rail of the sliding element so that they are linearly movable.

Advantageously, it is contemplated that the member axes of the transmission members are disposed at an acute angle so that they are rotatable relative to each other around an axis perpendicular to the central axis. Owing to their connections to the activation element and to each other, the transmission members are rotatable relative to each other in a plane parallel to the central axis and therefore about at least one axis of rotation or an axis perpendicular to the central axis. Here, the member axes of the two transmission members are arranged at an acute angle with respect to each other. When compensating different positions of the coupling elements the two transmission members therefore move in a common plane which is oriented parallel to the central axis.

In one embodiment, it is contemplated that the transmission members are implemented as planar disks and have a bore on the first end and on the second end, respectively, and the bores on the first end are respectively connected to an activation element by means of a bolt, and the bores on the second end are connected to each other by means of a bolt, the bolt which connects the two second ends to each other protruding into the sliding rail in sliding fit. In this embodiment, the rotatable support between the transmission members and the activation elements is realised by a combination of bores and bolts inserted into them. Preferably, bores are also integrated in the activation elements so that bolts can be inserted through the bores in the activation elements and the transmission members. Here, a sliding fit exists at least between the activation element and the transmission members. The same applies to the connection of the two transmission members through the bores on their second ends; here as well, at least one connection between a bolt and a bore is implemented as a sliding fit. Alternatively, likewise, all connections may be implemented as sliding fits, and the bolts may be secured against falling out by additional elements, for example, by one or a plurality of collars which project beyond the bolt in the radial direction. In addition, the bolt which connects the two second ends of the transmission members projects into the sliding rail of the sliding element so that the two transmission members are guided relative to the sliding element and supported.

In an advantageous implementation, it is contemplated that the compensation mechanism comprises four transmission members respectively two of which are rotatably connected to each other, and respectively two transmission members connected to each other are disposed on sides of the sliding element disposed opposite of each other radial to the central axis and connected to activation elements, altogether at least four activation elements being provided respectively two of which are connected to a coupling element. In this embodiment, the compensation mechanism comprises two pairs of transmission members which respectively connect two activation elements to the sliding element. These pairs of transmission members are preferably arranged so that they are symmetrical to the central plane of the sliding element. For ensuring a stable functioning of the compensation mechanism, one pair of transmission members is sufficient. The provision of a plurality of pairs of transmission members results in a distribution of the forces or loads acting on a plurality of components so that the compensation mechanism is more stable and less susceptible to damage. It is also possible to provide more than two pairs of transmission members which are respectively connected to two activation elements and the sliding element. Preferably, a plurality of pairs of transmission members are regularly disposed in the circumferential direction around the central axis.

In another embodiment, it is contemplated that the sliding rail, at least partly, extends through the sliding element radial to the central axis, and respectively two adjacent second ends of the transmission members are connected to each other by means of a bolt, these two bolts projecting into the sliding rail from sides disposed opposite of each other radial to the central axis and being, independent of each other, slidably supported in the sliding rail. In this embodiment, two pairs of transmission members are provided which are respectively connected to a bolt which also protrudes into the sliding rail at their second ends. The two bolts which protrude into the sliding rail are guided in it so that they are linearly movable independent of each other. When the compensation mechanism is in operation to compensate different positions of the coupling elements the two bolts projecting into the sliding rail move along the sliding rail in opposite directions.

Skillfully, it is contemplated that the coupling elements, the activation elements, and the compensation mechanism are, at least in portions, disposed in the interior of the basic body. In this way, the basic body acts like a protective housing for the other components which protects these components against contamination and damage.

In another embodiment, it is contemplated that the central portion has an internal guide, a guiding spike being introduced through the internal guide of the central portions of the two coupling elements in sliding fit and guiding the two coupling elements relative to each other in the direction of the central axis, the guiding spike being connected to the sliding element and extending parallel to the central axis. In this embodiment, a guide comprising a guiding spike and two internal guides disposed in the coupling elements is provided. The guiding spike is fixedly connected to the sliding element and extends from the sliding element through both internal guides parallel to the central axis. Preferably, the guiding spike is formed like a sword. This guide is provided to prevent a rotation of the two coupling elements relative to the sliding element. However, at the same time, this guide allows for an independent movement of the two coupling elements relative to the sliding element.

In one embodiment, it is contemplated that the actuator comprises a force limitation unit which limits the force which, from the actuator, acts on the activation element or the compensation mechanism for moving the coupling element parallel to the central axis. Such a force limitation unit has the effect that, during an operation of the actuator, the force generated by it and with it also the clamping force between two opposing clamping elements on the object to be clamped is limited. In this way, on the one hand, damage to the object between the clamping elements is avoided and, on the other hand, a reproducible, repeated clamping of the same object is ensured. Owing to the force limitation unit, the object is always clamped with the same clamping force even when repeatedly clamped so that a positioning of the object in the clamping device is ensured which can be repeated with extreme accuracy. The force limitation unit may be formed, for example, by a slide coupling which only transmits a force or a torque up to a threshold value and uncouples the actuator from the components connected to it in case of values exceeding the threshold value. Such a slide coupling is known from, for example, torque wrenches or torque limiting drill chucks.

Also disclosed is a testing machine for inspecting objects by detecting force-path interrelations, the testing machine comprising a testing slide which is designed so that it is shiftable at least along a spatial axis, a clamping device according to one of the previously described embodiments being attached to the testing slide by means of its interface, the central axis of the clamping device being oriented parallel to the a spatial axis in which the testing slide is shiftable, and the object to be inspected being clampable by at least two clamping elements of the clamping device. The disclosed testing machine is provided for detecting force-path interrelations during the examination of the properties of objects. The testing machine comprises a drivable testing slide as well as sensors for continuously detecting the movement and the forces acting on the testing slide. The testing machine further comprises a clamping device according to one of the previously described embodiments in which the object to be inspected is clamped or clampable. The compact, simple design of the clamping device as well as the secure centred positioning of an object in the clamping device result in that the testing machine can be operated in a simple manner and provides for extremely reproducible test results. The testing machine may be used, for example, to detect and analyse the force-path interrelation while press fitting an object into a test standard. Alternatively, the clamping device can also be used in a work machine, for example, a lathe or a milling machine. In this case, an object to be machined is clamped in the clamping device and machined by the work machine in the clamped state.

The object of the invention is further solved by a testing device for optically inspecting or measuring an object, the testing device comprising at least one object receptacle rotatable about at least one axis of rotation, the object receptacle comprising at least one clamping device according to one of the previously described embodiments, the central axis of the clamping device being oriented coaxial to the axis of rotation, a camera unit being provided which comprises at least one camera which is directable towards an object clamped in the clamping device, the camera transmitting captured images to a calculating unit which is configured to calculate a volume model from a plurality of images and to inspect or measure the volume model according to at least one test specification.

The testing device according to the invention is used to examine or to measure objects. This may take place, for example, in production, a produced object being examined for conformity with a test specification by means of the testing device. Here, the inspection is performed optically and contactlessly which is advantageous in that the object is not contacted and potentially deformed or damaged unintentionally here. Therefore, the testing device according to the invention is particularly suitable for inspecting delicate, susceptible objects. The testing device comprises an object receptacle which is provided for accommodating an object to be inspected. This object receptacle is rotatable about an axis of rotation and preferably movable automatically, for example, by an electric motor. The object receptacle comprises a clamping device according to the invention according to one of the previously described embodiments. The clamping device is connected to a complementary shaped counter-interface on or in the object receptacle by means of its interface. Here, the central axis of the clamping device is oriented coaxial to the axis of rotation of the object receptacle. During a rotation of the object receptacle, the clamping device therefore rotates about its central axis. The testing device further comprises at least one camera unit which is provided for optically detecting an object positioned in the clamping device. The camera unit, in turn, comprises at least one camera which is directable towards an object clamped in the clamping device. It is also possible to provide a plurality of cameras or a camera having different, exchangeable objective lenses. In operation of the testing device, the camera captures a plurality of images of the object and transmits them to a calculating unit. The calculating unit calculates a volume model of the object from the images and data on the rotation of the object receptacle in-between capturing the individual images. This volume model is a virtual model of the object and may subsequently be examined or measured instead of the real object. This inspection or measurement is performed according to at least one test specification. A test specification may be, for example, a set of data in which target dimensions of the object to be measured are stored. The testing device measures the calculated volume model and verifies the conformity of the actual dimensions with stored target dimensions. An advantage of the testing device according to the invention is that objects having an irregular cross section can be clamped in the clamping device in the object receptacle in a simple manner and with a high reproducibility. In this way, the testing device can be easily operated and provides for test or measuring results which can be repeated with high accuracy. The clamping device of the object receptacle results in that the object is fixed coaxial to the axis of rotation of the object receptacle. In addition, the clamping force of the object in the clamping device can be adjusted in a simple manner so that damage to or a deformation of the object during clamping is avoided.

In one embodiment of the testing device, it is contemplated that the testing device rotates the object receptacle together with the clamping device and the object clamped therein about the axis of rotation, the camera capturing a plurality of images of the object in various rotational positions about the axis and transmitting them to the calculating unit. During the inspection, the testing device rotates the object to be inspected together with the object receptacle and the clamping device. In the process, the camera captures a plurality of images of the object in various rotational positions. Here, a rotational angle sensor which detects the rotational positions and transmits them to the calculating unit is provided in or on the object receptacle. The calculating unit calculates a volume model based on a plurality of images which are respectively linked to the associated rotational positions in which the image was captured. The volume model calculated in this way may then be displayed and measured on a screen.

The object of the invention is finally solved by a method for measuring an object using a testing device according to one of the previously described embodiments comprising the process steps of:
A) clamping an object to be measured between the clamping elements of the clamping device,
B) rotating the object receptacle about the axis of rotation, the camera capturing a plurality of images of the object accommodated in the clamping device during the rotation,
C) transmitting the images from the camera to the calculating unit,
D) calculating a volume model of the object based on the images by the calculating unit,
E) measuring the volume model, the measurement being performed based on at least one test specification already stored or input by an operator.

The method according to the invention serves the measurement or inspection of an object. For performing the method, a testing device according to one of the previously described embodiments is used. Therefore, the use of a clamping device in a testing device and the use the testing device for carrying out the method is also disclosed.

In a first process step A), an object to be measured is clamped between the clamping elements in the clamping device. To this end, at least one actuator of the clamping device is operated.

In a second process step B), the object receptacle is rotated about its axis of rotation by the testing device, the camera capturing a plurality of images of the clamped object in various rotational positions.

In a third process step C), the images captured in process step B) are then transmitted to a calculating unit. It is also possible to perform process steps B) and C) simultaneously or in parallel.

In a fourth process step D), a volume model of the object is calculated from the images and the rotational positions of the object receptacle linked thereto.

In a fifth process step E), the volume model is now measured. The basis for this is constituted by at least one test specification. The test specification may be constituted by an operator entering associated commands for measuring the volume model to the testing device. The test specification may also be constituted by an inspection plan already stored in the testing device which is automatically carried out by the testing device without any further direct input by the operator. The inspection according to a stored inspection plan is preferably used for inspecting a plurality of objects of identical design to obtain reproducible measurement results.

The method according to the invention can be easily performed and, owing to the use of the clamping device according to the invention, results in reproducible and extremely accurate results of the measurement. Here, the clamping device according to the invention particularly facilitates process step A) of clamping the object in the inspection receptacle.

Features, effects, and advantages disclosed in connection with the clamping device and the testing device are also deemed disclosed in connection with the method. The same applies in the reverse direction; features, effects, and advantages disclosed in connection with the method are also deemed disclosed in connection with the clamping device and the testing device.

### BRIEF DESCRIPTION OF THE DRAWINGS

In the Figures, embodiments of the invention are schematically illustrated. Here,

FIG. 1 shows a perspective view of a first embodiment of a clamping device according to the invention,

FIG. 2 shows a perspective view of the components of the first embodiment of FIG. 1 disposed within the basic body,

FIG. 3 shows a perspective view of the first embodiment of FIG. 1 with components partly removed,

FIG. 4 shows a perspective view of a second embodiment of a clamping device according to the invention,

FIG. 5 shows a perspective view of the components of the second embodiment of FIG. 4 disposed within the basic body,

FIG. 6 shows a perspective view of a subsection the components of the second embodiment of FIG. 4 disposed within the basic body,

FIG. 7 shows a perspective view of the second embodiment illustrated in FIGS. 4, 5, and 6 including a guiding spike.

### DETAILED DESCRIPTION

In the Figures, identical elements are designated by the same reference numerals. Generally, the described properties of an element described with reference to one Figure also apply to the other Figures. Directional information such as above or below refer to the described Figure and are to be applied to other Figures according to their meaning.

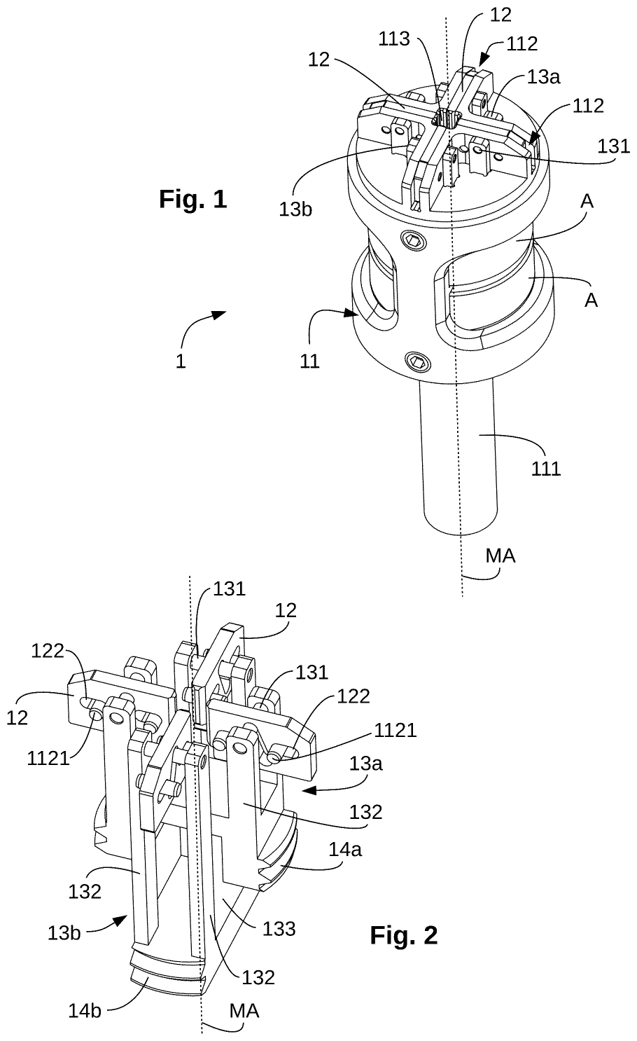

FIG. 1 shows a perspective view of a first embodiment of a clamping device 1 according to the invention. In the illustrated first embodiment, the two pairs of clamping elements 12 disposed opposite of each other are respectively movable in a direction radial to the central axis MA by a separate actuator A. The length of the clamping device 1 in the direction of the central axis MA is small, and the clamping device I has a simple design and therefore also a low weight due to a small number of components. The basic body 11 extends along the central axis MA and supports or accommodates the other components in its interior. On the end facing downwards, an interface 111 implemented as a cylindrical pin for the connection to a device, for example, a testing device is disposed. On the face side of the basic body 11 facing upwards, four guides 112 are disposed which extend radial to the central axis MA. Respectively two of these guides 112 are disposed opposite of each other with respect to the central axis MA. The guides 112 are respectively offset by 90° with respect to each other in the circumferential direction around the central axis. In each of the guides 112, a disk-shaped clamping element 12 is integrated. The guides 112 are implemented as grooves in the basic body 11 which transition into the receiving space 113 in the centre. The receiving space 113 is implemented as a hollow space which is provided to accommodate a subsection of an object to be clamped. In a plan view from the direction of the central axis MA, the receiving space 113 has a square cross section. The clamping elements 12 are supported in the respective guides 112 so that they are linearly movable radial to the central axis MA. This support is formed by the grooves which form cavities in the basic body 11. Details of the clamping elements 12 and the guides 112 are illustrated in FIG. 2. The clamping device I comprises two coupling elements 13a and 13b respectively one of which is kinematically coupled to two clamping elements 12 disposed opposite of each other. This kinematic coupling is established by respectively two transmission elements 131 associated with a coupling element 13a, 13b which are in operational connection with respectively one coupling surface 121 of a clamping element 12. Details of this operational connection are illustrated a FIG. 2. The upper ends of the coupling elements 13a, 13b which can be seen in FIG. 1 are respectively disposed adjacent to a guiding edge of a guide 112. The guiding edge defines the cavity of the guide into which the clamping element 12 is movably introduced. The guiding edge projects beyond adjoining portions of the basic body 11 which are oriented perpendicular to the central axis MA. The projecting guiding edge renders the easy arrangement of recesses possible which extend tangential to the circumferential direction around the central axis MA. These recesses can be used for passing-through an insertion element 1121 or a transmission element 131. In the illustrated embodiment, the guiding edge of each guide 122 has recesses disposed at a distance from each other in the radial direction to the central axis for introducing and fixing respectively one insertion element 1121. The insertion elements 1121 are pressed into these recesses. The insertion elements 1121 and their connection to the guide element 12 can be seen in FIG. 2. The guiding edge of each guide 112 further includes a recess which is provided for passing-through a transmission element 131 towards the guide element 12. This recess is formed by an elongated hole which extends through both guiding edges associated with a guide 112 tangential to the circumferential direction to the central axis, the longer side of this elongated hole being oriented parallel to the central axis MA. In this way, this elongated hole guides the transmission element 131 connected to a coupling element 13a, 13b in the direction of the central axis MA. In the illustrated embodiment, the disk-shaped clamping elements 12 are introduced into respectively one guide 112 in sliding fit. In the illustrated first embodiment, the clamping device comprises two actuators A which, in portions, are disposed in the interior of the basic body 11. These actuators A are in operational connection to the activation elements 14a, 14b disposed in the interior which are illustrated in FIG. 2. Each actuator A comprises a nut supported so that it is rotatable about the central axis MA and including a female thread. This nut is knurled on its outer circumference and can therefore be rotated relative to the central axis MA in a simple manner with the aid of the fingers. The nut is supported in the basic body 11 so that it is linearly immobile in the direction of the central axis MA. As a result of a rotation of the nut, the activation element 14a, 14b and with it the coupling element 13a, 13b is set into a linear movement parallel to the central axis MA by an interaction of its female thread with a male thread on the activation element 14a, 14b. In the illustrated embodiment, the two coupling elements 13a, 13b can respectively be independently moved by a separate actuator A in this way so that, indirectly, one of the two pairs of clamping elements 12 disposed opposite of each other can be moved towards or away from the central axis in the radial direction by an operation the two actuators.

FIG. 2 shows a perspective view of the components of the first embodiment of FIG. 1 disposed within the basic body 11. In the illustration of FIG. 2, the basic body 11 and the two actuators A which can be seen in FIG. 1 are not illustrated. In this way, the components illustrated in the interior of the basic body 11 can be seen more readily. Disposed opposite of each other in pairs, respectively, the four clamping elements 12 can be seen. Each of these clamping elements 12 has three continuous recesses which extend completely through the clamping element 12 tangential to the circumferential direction around the central axis MA. The respectively central recess is implemented as an elongated hole the longer side of which is oriented so that it is inclined, particularly at an acute angle, with respect to the central axis MA. The inner surfaces of the elongated hole on the longer sides respectively form a coupling surface 121. Therefore, in this embodiment, each clamping element comprises two coupling surfaces 121 arranged parallel to each other and disposed opposite of each other. Two other recesses in each clamping element 12 respectively form a guide recess 122. These guide recesses 122 are also formed by elongated holes, respectively, the longer side, however, being oriented radially and therefore at right angles to the central axis MA in these elongated holes. The guide recesses 122 serve to guide the clamping element 12 radial to the central axis MA but to fix it parallel to the central axis MA in the respective guide 112. To this end, respectively two insertion elements 1121 which also extend through a guide recess 122, respectively, are introduced through the two guiding edges per clamping element 12 which are disposed opposite of each other with respect to a clamping element 12. The insertion elements 1121 are implemented as cylindrical pins and fixed in a cylindrical bore in each guiding edge by press fitting. Each insertion element 1121 projects into one of the guide recesses 122 in sliding fit. This combination of insertion elements 1121 and a guide recess 122 results in that the clamping elements 12 can linearly move relative to the insertion elements 1121 in the longitudinal direction of the guide recesses 122 implemented as elongated holes and therefore radial to the central axis MA. However, movements in other directions or rotations of the clamping elements 12 relative to the basic body 11 are prevented by this combination. It is also possible to realise a radially movable support of the clamping elements 12 relative to the basic body 11 in another way. The interaction of the recesses and the coupling surfaces 121 and the transmission elements 131 functions in a similar manner: Between respectively two opposing supports 132 of a coupling element 13a, 13b, respectively one transmission element 131 implemented as a cylindrical pin is fixedly introduced. Between the supports 132, the transmission element 131 is guided in sliding fit in the central recess in the clamping element 12 which comprises the coupling surfaces 121. Therefore, the transmission element 131 is shiftable parallel to the coupling surfaces 121 inside the central recess. When a transmission element 131, guided by a coupling element 13a, 13b and/or a recess in the guiding edges, is moved parallel to the central axis MA the clamping element 12 slides along the transmission element 131 parallel to the coupling surface 121. In this way, the movement of the transmission element 131 oriented parallel to the central axis MA is translated into a movement of the clamping element 12 oriented radial to the central axis MA by the inclined coupling surfaces 121. In the illustrated embodiment, the coupling elements 13a, 13b are respectively implemented so that they are rigid and comprise an integral basic body into which the transmission elements 131 implemented as cylindrical pins are introduced in press fit. In the illustrated embodiment, the two coupling elements 13a, 13b are formed so that they are substantially symmetrical to the central axis MA but different from each other in their shape. The coupling elements 13a, 13b, in portions, interpenetrate or engage around each other and are therefore, at least in portions, insertable into each other in the direction of the central axis MA. In this way, an independent movement of the coupling elements 13a, 13b in the direction of the central axis MA is rendered possible without a collision taking place. The coupling elements 13a, 13b have a fork-shaped design in their subsection facing upwards and respectively comprise four supports 132 extending in the direction of the central axis MA in the illustrated embodiment. These supports 132 are spaced apart from each other radial to the central axis MA or tangential to the circumferential direction around the central axis MA. Respectively two supports 132 which are spaced apart from each other tangential to the circumferential direction around the central axis MA carry a transmission element 131. On the side of the supports 132 disposed opposite of the transmission elements 131, they are connected by a central portion 133 which is oriented perpendicular to the central axis MA. On each of the supports 132, a plurality of sliding surfaces 1321 is disposed which are arranged on the outer circumference of each support 132. These sliding surfaces 1321 abut on subsections of the basic body 11 and, together with these, form a sliding bearing of the coupling elements 13a, 13b in the basic body 11 in the direction of the central axis. Such a sliding bearing is readily realisable and benefits a compact design with low requirements on installation space. The distance between supports 132 disposed opposite of each other in the direction radial to the central axis is identical in two coupling elements 13a, 13b. In the illustrated first embodiment, the two activation elements 14a, 14b are respectively formed by subsections of the coupling elements 13a, 13b. Each activation element 14a, 14b is formed by a subsection of a coupling element 13a, 13b projecting in a direction radial to the central axis MA on which a male thread is disposed which extends along the central axis MA. In the mounted state of the clamping device 1, this male thread is in engagement with a female thread which is disposed in the nut of an actuator A. The activation element 14a, 14b is moved in the direction parallel to the central axis MA by a rotation of the nut, this movement being directly transmitted to the coupling element 13a, 13b. The activation elements 14a, 14b are spaced apart from the transmission elements 131 in the direction of the central axis MA. As an alternative to the illustrated embodiment, the coupling elements 13a, 13b may also be assembled from a plurality of individual components. For a compact design having small dimensions, particularly for a clamping device 1 for small, delicate parts, the illustrated integral embodiment is advantageous. If the clamping device 1 has larger dimensions, a multi-part design of the coupling elements 13a, 13b is recommendable.

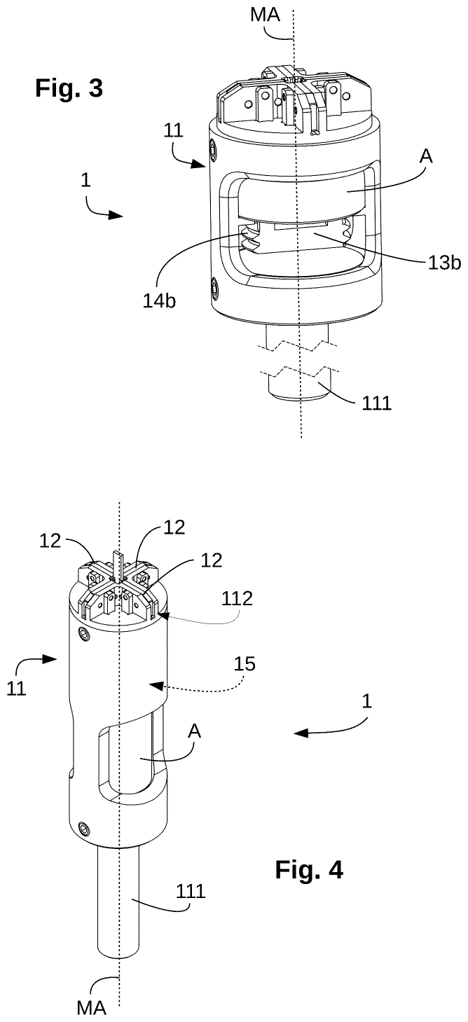

FIG. 3 shows a perspective view of the first embodiment of FIG. 1 with components partly removed. FIG. 3 serves the illustration of the operating principle of the actuators A. In FIG. 3, the first embodiment of a clamping device 1 of FIG. 1 is illustrated. However, the lower actuator A as well as a coupling element 13a and an activation element 14a were removed in the illustration of FIG. 3 so that these components are not illustrated. In this way, the remaining coupling element 13b and the remaining activation element 14b can be seen in the mounting position in the interior of the basic body 11. In the interior of the basic body 11, there is a hollow space in which the coupling elements 13a, 13b as well as the activation elements 14a, 14b have sufficient free space to be capable of moving in the direction of the central axis MA. The male thread of the activation element 14b protrudes beyond the coupling element 13b towards the outside in a direction radial to the central axis MA. Below the illustrated, knurled nut of the first actuator A, an identical nut is incorporated which has a female thread which comes into engagement with the male thread on the activation element 14b during the assembly of the clamping device 1. The nuts of the two actuators A are immobile in the basic body 11 in the direction of the central axis MA but supported so that they are rotatable about the central axis MA. During a rotation of the nut of an actuator A, it remains in its position in the basic body 11, and a linear movement of the associated coupling element 13a, 13b in the direction of the central axis MA is induced by means of the interaction of the threads. In the illustrated embodiment, the actuators A are therefore disposed outside of the coupling elements 13a, 13b in the radial direction, but parallel thereto in the direction of the central axis MA. This results in a compact length of the clamping device 1 in the direction of the central axis MA which benefits a good concentricity of the clamping device 1 and therefore of an object clamped in the clamping device 1. With regard to components not described in connection with FIG. 3, the description relating to FIGS. 1 and 2 is made reference to.

FIG. 4 shows a perspective view of a second embodiment of a clamping device 1 according to the invention. The illustrated second embodiment comprises a compensation mechanism 15 not visible in FIG. 4 which couples the movements of clamping elements 12 arranged opposite of each other to each other in a compensating manner. The second embodiment comprises only one actuator A which serves to operate the clamping device I when clamping or unclamping an object. The basic body 11 of the second embodiment is identical in design to the first embodiment illustrated in FIG. 1 on the face side facing upwards and with respect to the shape and the position of the interface 111 in the area of the guides 112. Therefore, for these subsections of the basic body 11, the description relating to FIG. 1 is made reference to. The central portion of the basic body 11 comprises two openings which render an accessibility of the actuator A in the interior of the basic body 11 possible. In this embodiment as well, the actuator A comprises a nut having a knurled outer circumferential surface which has a female thread in its interior which is in operational connection to a subsection of the compensation mechanism 15.

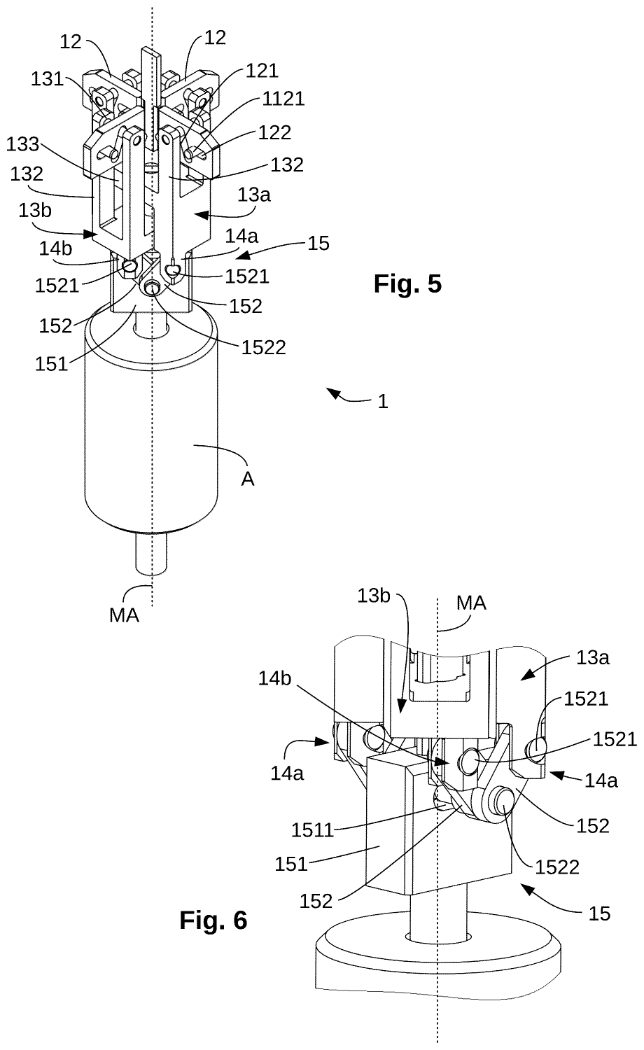

FIG. 5 shows a perspective view of the components of the second embodiment of FIG. 4 disposed within the basic body 11. In FIG. 5, the basic body 11 illustrated in FIG. 4 is not illustrated. The components disposed, at least in portions, in the interior of the basic body 11 are partly identical to the first embodiment. The four clamping elements 12 including their recesses and support are identical to the first embodiment. Further, the upper subsections of the coupling elements 13a and 13b including the supports 132 and the transmission elements 131 are identical to the first embodiment. With regard to the details as well as the operating principle and the support of these components in the basic body 11, therefore, the description relating to the first embodiment of FIGS. 1 and 2 is made reference to. In the second embodiment, the coupling element 13a is implemented so that it is longer than in the first embodiment in the direction of the central axis MA. In the second embodiment, the two coupling elements 13a, 13b have a substantially identical length in the direction of the central axis. This is required for the connection to the compensation mechanism 15 disposed below them. In the second embodiment, the two activation elements 14a and 14b are different in design as compared to the first embodiment and arranged in another position relative to the coupling elements 13a, 13b. In the second embodiment, the activation elements 14a and 14b are implemented as subsections of the coupling elements 13a and 13b. The activation elements 14a, 14b are located on the side of the coupling elements 13a, 13b disposed opposite of the transmission elements 131 in the direction of the central axis MA and extend away from the coupling elements 13a, 13b in the direction of the central axis MA. Each activation element 14a, 14b has two subsections disposed parallel to each other and spaced apart from each other. Into the distance between these subsections, a transmission member 152 can be introduced, respectively. The shape of the activation elements 14a, 14b can be seen more readily in FIG. 6. The clamping device 1 according to the second embodiment comprises a compensation mechanism 15 which is, on the one hand, connected to the activation elements 14a, 14b and, on the other hand, to an actuator A. The compensation mechanism 15 is provided to compensate a difference in the position of the coupling elements 13a, 13b in the direction of the central axis MA. Such a difference in the position of the coupling elements 13a, 13b occurs when the clamping elements 12 kinematically coupled thereto abut on an object to be clamped having an irregular cross section. For example, if an object having a square cross section is introduced into the receiving space 113 one pair of opposing clamping elements 12 will abut on the object before the other pair of clamping elements 12 abuts on the object during a movement of the clamping elements 12 radial to the central axis MA towards the inside. In this case, the pair of clamping elements 12 not yet in abutment can move further towards the object until this pair of clamping elements 12 is also in abutment. In the interval in which the first pair of clamping elements 12 is already in abutment but the second pair of clamping elements 12 can still move inwards, the coupling element 13a, 13b which is coupled to the clamping elements 12 still moving moves further along the central axis MA. Therefore, the position of the one coupling element 13a, 13b relative to the position of the other coupling element 13a, 13b changes until the second pair of clamping elements 12 is in abutment. In order to be capable of moving the other pair of clamping elements 12 further towards the object after the first pair of clamping elements 12 abuts on the object, the compensation mechanism 15 is provided. The compensation mechanism 15 renders the autonomous, centred clamping of an object having an irregular cross section between the four clamping elements 12 by an operation of a single actuator A possible. Particularly in the second embodiment including the compensation mechanism 15, operating the clamping device 1 is extremely easy and, due to the autonomous centration, results in reproducible results even in case of a repeated clamping of the same object in the clamping device 1. The compensation mechanism is disposed on the side of the coupling elements 13a, 13b disposed opposite of the clamping elements 12 in the direction of the central axis MA. The compensation mechanism 15 comprises a sliding element 151 which is connected to the actuator A disposed below it. For this purpose, a subsection of the sliding element 151 is implemented as a threaded bolt having a male thread which extends away from the coupling elements 13a, 13b along the central axis MA. The actuator A comprises a nut knurled on its outer circumference which has a female thread in its interior. The male thread of the threaded bolt is introduced into the female thread of the nut. When the nut is rotated about the central axis MA, this rotation is translated into a movement of the sliding element 151 along the central axis MA by the interaction the threads. For this purpose, the nut is rotatable in the basic body 11 but supported so that it is linearly immobile in the direction of the central axis MA. In the sliding element 151, a sliding rail 1511 is integrated which is formed by a recess which extends through the sliding element 151 in a direction perpendicular to the central axis MA. The sliding rail 1511 is implemented as an elongated hole the longer side of which is oriented perpendicular to the central axis MA. In the illustrated embodiment, the sliding rail 1511 extends completely through the sliding element 151 and is accessible from two opposite sides in this way. Alternatively, it is possible that the sliding rail 1511 extends only partly through the sliding element 151. The compensation mechanism 15 further comprises at least two transmission members 152 which movably connect the activation elements 14a, 14b to the sliding element 151. In the illustrated embodiment, the compensation mechanism 15 comprises altogether four transmission members 152 only two of which, however, are illustrated or to be seen. In the illustrated embodiment, the transmission members 152 are implemented as planar disks and formed similar to chain links. Each transmission member 152 extends in the longitudinal direction along a member axis. Each transmission member 152 has a bore on a first end and another bore on a second end disposed opposite of the first end in the direction of the member axis. Each transmission member 152 is rotatably connected to an activation element 14a, 14b on a first end. This connection is respectively established by a bolt 1521 which is passed through the bore on the first end of each transmission member 152 and through associated bores in an activation element 14a, 14b. For example, the bolt 1521 may be mounted in press fit in the bores in the activation element 14a, 14b and in sliding fit in the bore on the first end of the transmission member 152. In this way, the transmission members 152 are rotatably supported relative to the activation element 14a, 14b and the coupling element 13a, 13b in a plane parallel to the central axis MA. The second ends of the transmission members 152 are rotatably connected to each other by a bolt 1522 through the bores disposed there. The bolt 1522 extends through the two bores in the second ends of the transmission members 152 and further protrudes into the sliding rail 1511 in the sliding element 151. Between at least one bore in a second end of a transmission member 152 and the bolt 1522, a sliding fit is established which renders a relative rotation of the components with respect to each other possible. At the same time, a sliding fit also exists between the outer circumference of the bolt 1522 and the surfaces of the sliding rail 1511 facing inwards so that the bolt 1522 is shiftable along the sliding rail 1511 in a direction perpendicular to the central axis MA. The member axes of the transmission members 152 are disposed at an acute angle to each other in a plane parallel to the central axis MA and rotatable with respect to each other about an axis perpendicular to the central axis MA. The details of the construction of the compensation mechanism 15 may also be modified to obtain the same or a comparable effect. The activation elements 14a, 14b are respectively connected to a transmission member 152 rotatable in a plane parallel to the central axis MA. The ends of the transmission members 152 disposed opposite of this connection, in turn, are also rotatably connected to each other in a plane parallel to the central axis MA. In addition, the second ends of the transmission members 152 are slidably supported in a sliding element 151 in a direction perpendicular to the central axis MA. The sliding element 151, in turn, is disposed in the basic body 11 so that it is linearly movable in the direction of the central axis MA. The compensation mechanism 15 functions as follows: First, a component having an irregular cross section is placed between the four clamping elements 12. Then, the actuator A is operated which results in the sliding element 151 being moved away from the clamping elements 12 in the direction of the central axis MA. This linear movement of the sliding element 151 is transmitted to the coupling elements 13a, 13b which also move away from the clamping elements 12 in the direction of the central axis MA in this way via the transmission members 152 and the activation elements 14a, 14b. Due to the kinematic coupling of the coupling elements 13a, 13b to the clamping elements 12, the movement of the coupling elements 13a, 13b is translated into a radial movement of the clamping elements 12 towards central axis MA. Due to the irregular cross section, one pair of opposing clamping elements 12 abuts on the object while there is still a distance between the clamping elements 12 of the other pair and the object. The coupling element 13a, 13b which is connected to the clamping elements 12 which already abut on the object will now remain in its position relative to the central axis MA. Due to the further movement of the sliding element 151 by the operation of the compensation mechanism 15, the other coupling element 13a, 13b is then moved further away from the clamping elements 12 so that the second pair of clamping elements moves further towards the object. From the point in time from which the first coupling element 13a, 13b is not moved further in the direction of the central axis MA, the transmission members 152 rotate around their connection points to the activation elements 14a, 14b and around their connection point to each other. At the same time, the bolt 1522 which connects the second ends of the transmission members 152 to each other is shifted within the sliding rail 1511. As soon as the second pair of clamping elements 12 also abuts on the object, the rotational movement of the transmission members 152 ends. A further movement of the sliding element 151 in the direction of the central axis MA is then again transmitted to both coupling elements 13a, 13b and therefore to all four clamping elements 12 via the compensation mechanism 15. With a slight further movement of the sliding element 151 in the direction of the central axis MA, the object is finally non-positively clamped by the interaction of the components kinematically coupled to each other. On principle, it is sufficient that altogether two activation elements 14a, 14b and altogether two transmission members 152 are provided to realise a compensation mechanism 15 according to the introduced operating principle. However, the illustrated second embodiment comprises altogether four activation elements 14a, 14b and four transmission members 152. Details relating thereto are described in connection with FIG. 6.

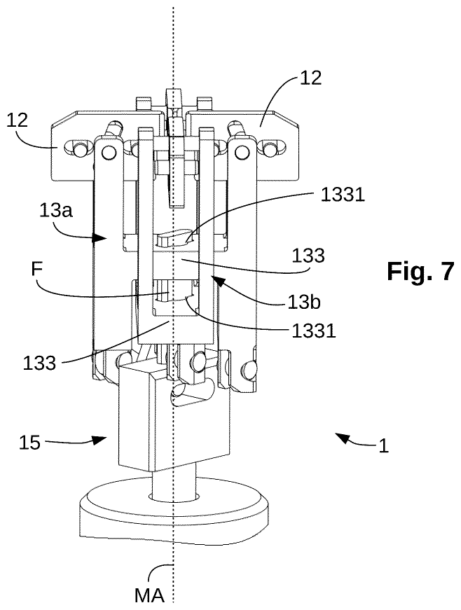

FIG. 6 shows a perspective view of a subsection of the components of the second embodiment of FIGS. 4 and 5 disposed within the basic body 11. In FIG. 6, the compensation mechanism 15 is illustrated in a perspective slightly changed as compared to the illustration in FIG. 5. In FIG. 6, it can be seen that the coupling element 13a is connected to two activation elements 14a. The activation element 14a illustrated on the right is connected to an activation element 14b of the other coupling element 13b via two transmission members 152. The other coupling element 13b is also connected to two activation elements 14b the rear one of which is concealed in the illustration. The left activation element 14a is also connected to the second activation element 14b of the other coupling element 13b via two transmission members 152. In the illustrated embodiment, the two coupling elements 13a, 13b are therefore connected to each other via altogether four activation elements 14a, 14b and four transmission members 152. The pairs of activation elements 14a, 14b and transmission members 152 are arranged on sides of the sliding element 151 disposed opposite of each other radial to the central axis MA. In this way, a symmetrical design of the compensation mechanism 15 is obtained which ensures a particularly good force transmission. Moreover, the risk of the compensation mechanism 15 getting jammed is considerably reduced by this symmetric design. It is also possible to provide additional pairs of activation elements 14a, 14b and transmission members 152 which, preferably, are regularly disposed in the circumferential direction around the central axis MA. When an object having an irregular cross section is clamped between the four clamping elements 14 and the compensation mechanism 15 compensates this irregular shape of the object during clamping as previously described the two bolts 1522 which project into the sliding rail 1511 move in opposite directions in the sliding rail 1511. For preventing a rotation of the sliding element 151 with respect to the coupling elements 13a, 13b while clamping or unclamping an object in the clamping device 1 a guiding spike F may be provided which is not illustrated in the illustrations in FIGS. 5 and 6 for the sake of clarity. Such a guiding spike F is illustrated in FIG. 7.

FIG. 7 shows a perspective view of the second embodiment illustrated in FIGS. 4, 5, and 6 including a guiding spike F. The embodiment illustrated in FIG. 7 corresponds to the embodiment presented in connection with FIGS. 5 and 6 but, in addition, comprises a guiding spike F which is guided by two internal guides 1331 in the central portions 133 of the coupling elements 13a, 13b. With regard to the components of the clamping device 1 not described in connection with FIG. 7, the description relating to FIGS. 5 and 6 is made reference to. For the sake of clarity, some components of the compensation mechanism 15, for example, the transmission members 152 are not illustrated in FIG. 7. The embodiments of FIG. 7 or FIGS. 5 and 6 can be freely combined with each other. In FIG. 7, a guiding spike F is provided which is fixedly connected to the sliding element 151 and extends upwards in the direction of the clamping elements 12 along the central axis MA. In a sectional plane perpendicular to the central axis MA, the guiding spike F has an irregular shape. The guiding spike F has the shape of a sword the width of which is considerably larger than its thickness. The internal guides 1331 have a shape complementary or negative to the cross section of the sword. The guiding spike F extends through both internal guides 1331 and is supported in these in sliding fit. In this way, the two coupling elements 13a, 13b can be linearly shifted relative to the guiding spike F in the direction of the central axis MA. With this support, the two coupling elements 13a, 13b can be moved independently. However, owing to the shape of the guiding spike F having an irregular cross section and the internal guides 1331, a rotational movement of each coupling element 13a, 13b about the central axis MA is prevented. In this way, it is ensured that the coupling elements 13a, 13b cannot rotate relative to the sliding element 151 connected to the guiding spike F. In this way, an undisturbed operation of the entire compensation mechanism 15 is ensured. Alternatively, also a plurality of guiding spikes F may be provided which may then also have a regular cross section such as, for example, a circular cross section. In case of a plurality of guiding spikes F, accordingly, also a plurality of internal guides having a shape complementary to the guiding spikes is integrated in the central portions 133.

### LIST OF REFERENCE NUMERALS

1 Clamping device
11 Basic body
111 Interface
113 Receiving space
112 Guide
1121 Insertion element
12 Clamping element
121 Coupling surface
122 Guide recess
13a, 13b Coupling element
131 Transmission element
132 Supports
1321 Sliding surface
133 Central portion
1331 Internal guide
14a, 14b Activation element
15 Compensation mechanism
151 Sliding element
1511 Sliding rail
152 Transmission member
1521 Bolt
1522 Bolt
A Actuator
F Guiding spike
MA Central axis

1. A clamping device for clamping or gripping an object comprising
a basic body which includes an interface for the connection to a working or testing machine, wherein the basic body extends along a central axis and includes at least four guides disposed opposite of each other in pairs which extend radial to the central axis,
at least four clamping elements respectively one of which, at least in portions, is introduced into a guide, wherein the guide supports and guides the clamping element radial to the central axis with a linear degree or freedom, and the clamping element has at least one coupling surface which is oriented so that it is inclined with respect to the central axis,
at least two coupling elements each of which is kinematically coupled to two clamping elements disposed opposite of each other radial to the central axis, wherein the coupling element comprises two transmission elements spaced apart from each other radial to the central axis which, at least in portions, extend tangential to the circumferential direction around the central axis, wherein each transmission element is or can be brought in contact with a coupling surface of a clamping element, and wherein the two coupling elements are supported in or on the basic body so that they are independently movable in a direction parallel to the central axis,
at least two activation elements each of which is connected to one of the coupling elements, wherein the activation elements are arranged so that they are independently movable relative to the basic body at least in a direction parallel to the central axis,
wherein, during a movement of an activation element in the direction of the central axis, the coupling element connected thereto also moves in the direction of the central axis and the interaction of the two transmission elements of the coupling element and respectively one coupling surface of a clamping element translates the movement of the coupling element into a movement of two clamping elements arranged opposite of each other radial to the central axis in the direction radial to the central axis.

2. The clamping device according to claim 1, wherein the guide has a cavity for accommodating a clamping element, wherein at least one insertion element is provided which protrudes into the cavity and is provided for the engagement in a clamping element to fix the clamping element in a direction parallel to the central axis, wherein the clamping element is movable radial to the central axis, and/or the clamping element, at least in portions, has a disk-shaped design and is introduced into a cavity disposed in the guide in sliding fit, and/or the coupling surface is disposed in a recess in the clamping element which, at least partly, extends through the clamping element tangential to the circumferential direction around the central axis.

3. The clamping device according to claim 1, wherein the coupling element, in portions, has a fork-shaped design, wherein at least two supports spaced apart from each other radial to the central axis are provided which, at least in portions, extend parallel to the central axis, wherein a central portion is disposed between the supports and connects the supports, and each support supports a transmission element, wherein a distance is present between the connection of the central portion to the supports and the connection of the transmission elements to the supports.

4. The clamping device according to claim 1, wherein a compensation mechanism is provided which is connected to the activation elements, wherein the compensation mechanism is provided to compensate a difference in the position of the coupling elements in the direction of the central axis and therefore a difference in the distance between clamping elements disposed opposite of each other radial to the central axis.

5. The clamping device according to claim 4, wherein the compensation mechanism comprises at least two transmission members which respectively extend along a member axis, wherein each transmission member is rotatably connected to an activation element at a first end, and the transmission members are rotatably connected to each other and connected to the sliding element so that they are linearly shiftable relative to the sliding rail at a second end disposed opposite of the first end in the direction of the member axis.

6. The clamping device according to claim 5, wherein the transmission members are implemented as plane disks and have a bore on the first end and on the second end, respectively, and the bores on the first end are respectively connected to an activation element by means of a bolt, and the bores on the second end are connected to each other by means of a bolt, wherein the bolt which connects the two second ends to each other protrudes into the sliding rail in sliding fit.

7. The clamping device according to claim 4, wherein the central portion has an internal guide, wherein a guiding spike is introduced through the internal guide of the central portions of the two coupling elements in sliding fit and guides the two coupling elements relative to each other in the direction of the central axis, wherein the guiding spike is connected to the sliding element and extends parallel to the central axis.

8. A testing device for optically inspecting or measuring an object, wherein the testing device comprises at least one object receptacle rotatable about at least one axis of rotation, wherein the object receptacle comprises at least one clamping device according to claim 1, wherein the central axis of the clamping device is oriented coaxial to the axis of rotation, wherein at least one camera unit is provided which includes at least one camera which is directable towards an object clamped in the clamping device, wherein the camera transmits captured images to a calculating unit which is configured to calculate a volume model from a plurality of images and to inspect or measure the volume model according to at least one test specification.

9. The testing device according to claim 8, wherein the testing machine rotates the object receptacle including the clamping device and the object clamped therein about the axis of rotation, wherein the camera captures a plurality of images of the object in various rotational positions about the axis and transmits them to the calculating unit.

10. A method for measuring an object using a testing device according to claim 8 comprising the process steps of:
A) clamping an object to be measured between the clamping elements of the clamping device,
B) rotating the object receptacle about the axis of rotation, wherein the camera captures a plurality of images of the object accommodated in the clamping device during the rotation,
C) transmitting the images from the camera to the calculating unit,
D) calculating a volume model of the object based on the images by the calculating unit,
E) measuring the volume model, wherein the measurement takes place based on at least one test specification already stored or input by an operator.

11. The clamping device according to claim 4, wherein the compensation mechanism is connected to an actuator via a sliding element, wherein the sliding element is movable in the direction of the central axis by the actuator.

12. The clamping device according to claim 11, wherein the sliding element comprises at least one sliding rail which is formed by a recess in the sliding element, wherein the sliding rail extends perpendicular to the central axis.
